(19) United States
(12) Patent Application Publication
(10) Pub. No.: US 2008/0272270 A1
(43) Pub. Date: Nov. 6, 2008

(54) Method of Constructing a Wall Using Hemp-and-Lime, Blocks Used for Same and Device for Molding Said Blocks

(75) Inventors: Jean-Paul Henri Robin, Saint-Philibert (FR); Renaud Jacques Michel Robin, Saint-Philibert (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: DEVELOPPEMENT CONSTRUCTION ECOLOGIQUE, Saint Philibert (FR)

(21) Appl. No.: 11/629,839

(22) PCT Filed: Jun. 13, 2005
(86) PCT No.: PCT/FR05/01458

§ 371 Date: Jul. 18, 2008

(30) Foreign Application Priority Data
Jun. 15, 2004 (FR) 0406438

(51) Int. Cl. E04B 1/12; B28B 7/18; E04G 11/06

(52) U.S. Cl. 249/18; 52/745.09; 52/606

(57) ABSTRACT

A method for building a wall out of lime and hemp, prefabricated blocks made of hemp and lime for the use of the method and a device for molding such prefabricated blocks.

### RELATED APPLICATIONS

This application claims priority to PCT Application No. PCT/FR2005/001458 filed Jun. 13, 2005, and French Application No. 0406438 filed Jun. 15, 2004, the disclosures of which are hereby incorporated by reference in their entireties.

### SUMMARY OF THE INVENTION

The present invention relates to a method for building a wall out of lime and hemp, prefabricated blocks made of hemp and lime for the use of the method and a device for molding such prefabricated blocks.

### BACKGROUND OF THE INVENTION

There are known ways of using mortar or concrete elements made of hemp or lime in construction work. For building walls, hemp-based mortar is traditionally shuttered in a wooden bearing frame. The hemp mortar is prepared on site, then poured and rammed down between two forms positioned around uprights of the wooden frame. This procedure proves to be particularly painstaking and costly because it especially necessitates the handling of corrosive material such as lime, the use of heavy means such as a mixer and forms, a very lengthy drying time of about one month and special expertise, especially in carpentry and masonry.

It has also been proposed to manufacture solid hemp bricks joined together to form a non-load-bearing wall around a wooden bearing structure. Such an implementation makes it possible to overcome at least one of the above-mentioned problems related to shuttering. However, the mounting of the non-load-bearing brick walls about preliminarily installed uprights of the wooden framework does not draw upon traditional techniques of masonry and calls for special expertise.

Consequently, despite their acknowledged properties in terms of thermal and hygrometric regulation, as well as their phonic qualities, hemp mortars are little used at present.

The aim of the present invention is to propose a method for the making of a wall out of hemp-and-lime-based mortar or concrete that is simple and quick to implement.

To this end, an object of the invention is a method for making a wall out of hemp and lime, characterized in that it comprises:

a) a step for assembling hemp-and-lime based prefabricated blocks provided with vertical channels in which the blocks are assembled in superimposed, horizontal rows so as to form vertical conduits with the vertical channels, the assembling of the blocks to one another being achieved by means of a binding material, preferably formed by fat lime,

b) a step for the insertion of posts, preferably made of wood, into the vertical conduits from the top, and

c) and a step for filling the vertical conduits with a filling material such as a milk-of-lime type binder to seal said posts into the blocks.

The term “vertical channel” is understood to mean a recess that opens into the upper face and lower face of the block, at a distance from the transversal faces as well as recess or depressions that open out into the upper face and the lower face of the block but are formed on the transversal faces. In this case, the vertical conduits for the insertion of the posts are formed especially by facing channels of two adjacent blocks of a same row.

Advantageously, the assembling step consists of the quincunxial stacking in superimposed rows of the prefabricated blocks provided with at least two vertical channels.

At each wall corner, door frame and/or partition wall junction, wider-sectioned conduits are formed out of specific blocks, into which there will be inserted several posts bound together or wider-sectioned posts.

In one embodiment, the first row is positioned on a sole plate, preferably made of wood, on which the posts take support. The method may include a step for fixing the posts to the sole plate, for example by means of connectors nailed to the sole plate and to the posts, to position the posts in the vertical conduits before the step for filling said conduits with said filling material. The method may furthermore include a step for fixing the posts by their upper ends to an upper purlin.

The present invention also proposes a prefabricated block made of hemp and lime for the implementation of the method, characterized in that it is made up of a parallelepiped-shaped single-piece body provided with vertical channels for the passage of posts. Each block preferably comprises at least one channel having a rectangular cross-section of at least 50×50 mm, preferably ranging from 50×50 mm to 200×200 mm.

According to one embodiment, the block comprises two vertical through-channels of substantially identical rectangular cross-section that open out on its upper and lower faces, placed symmetrically on either side of its transversal plane of symmetry and at a distance from its transversal sides, to form a solid wall block, the channels having cross-sections preferably ranging from 50×150 mm to 80×180 mm, preferably from 60×160 to 75×175 mm.

Another type of block may include two vertical through-channels of different rectangular cross-sections that open out on its upper and lower faces, at a distance from the transversal faces, one having a rectangular cross-section, preferably between 50×50 mm and 80×180 mm, preferably between 60×160 mm and 75×175 mm, and the other cross-section being bigger and square-shaped, preferably ranging from 80×80 mm to 200×200 mm, more preferably ranging from 150×150 to 180×180 mm, better still between 160×160 and 170×170 mm, to form a corner block whose widest-section channel is designed for the passage of particular stress-bearing posts such as corner posts, partition wall junction posts or window/door frame posts.

Advantageously, the block furthermore comprises secondary vertical channels for the passage of electrical sheaths and/or conduits.

The invention furthermore proposes a device for the molding of hemp-and-lime blocks as defined here above. The molding device of the invention is characterized in that it comprises a mold comprising a molding chamber formed by an upper wall surrounded by a side wall, said chamber being mounted so as to be vertically mobile on a chassis, and a counter-molding plate positioned on a support means and capable of closing the molding chamber; first shifting means to vertically shift the molding chamber between a top position in which the molding chamber is placed above the counter-molding plate for the stripping-off operation and a low position in which the counter-molding plate gets embedded in the molding chamber for the molding operation; tubes mounted so as to be vertically mobile on said chassis, capable of coming vertically into the chamber through apertures present in the upper wall of this chamber, elastically supported on the counter-molding plate in the low position of the molding chamber to form the vertical channels of the blocks; filling means to fill the chamber with hemp mortar in its low position; second shifting means to effect an additional relative vertical shift of the counter-molding plate with respect to the molding chamber in its low position to compress the mortar present in the molding chamber; and vibration means to make the mold vibrate, for example linearly, such as a vibrating table on which the chassis is mounted.

According to one particular feature, at least one of the tubes is hollow and is provided at its lower part with at least one aperture to enable the molding chamber to be filled with hemp and lime in its low position.

Advantageously, the device includes a conveyer capable of conveying counter-molding plates one by one to the support means facing the molding chamber and of removing them from said support means with the stripped-off blocks.

According to one embodiment, the second shifting means are capable of shifting the support means of the counter-molding plate.

Advantageously, the device has a screen mounted so as to be fixed on said chassis, said screen coming substantially against the upper wall of the chamber in its top position, preferably nested in a complementary counter-screen forming one piece with said upper wall and coming substantially to the level of the peripheral edge of the side wall of the molding chamber in its top position in order to facilitate the stripping of the blocks.

### BRIEF DESCRIPTION OF THE DRAWINGS

The invention will be understood more clearly and other details, features and advantages will appear more clearly in the course of the following detailed explanatory description of a presently preferred particular embodiment of the invention, made with reference to the appended schematic drawings, of which:

FIGS. 1 and 2 are respectively a view in perspective and a top view of a solid wall block according to an embodiment of the present invention;

FIG. 3 is a top view of a specific block according to an embodiment of the present invention;

FIG. 4 is a schematic view in perspective of a wall according to the invention made out of solid wall blocks of FIG. 1;

FIG. 5 is a schematic view in perspective of a wall corner made with specific blocks of FIG. 3;

FIG. 6 is a schematic view in section of a wall according to the invention with a window;

FIG. 7A is a partial side view of the lower part of a wall according to an embodiment of the present invention;

FIG. 7B is a view in section along the section VIIB of FIG. 7A;

FIG. 8 is a partial view in section of the upper part of a wall according to an embodiment of the present invention;

FIGS. 9 and 10 provide a schematic view of a molding device according to the invention, with the molding chamber respectively in the top position and in the bottom position;

FIG. 11 is a top view of a solid wall block according to another embodiment; and,

FIGS. 12A to 12D are different top views of special blocks.

While the present invention is amendable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION OF THE DRAWINGS

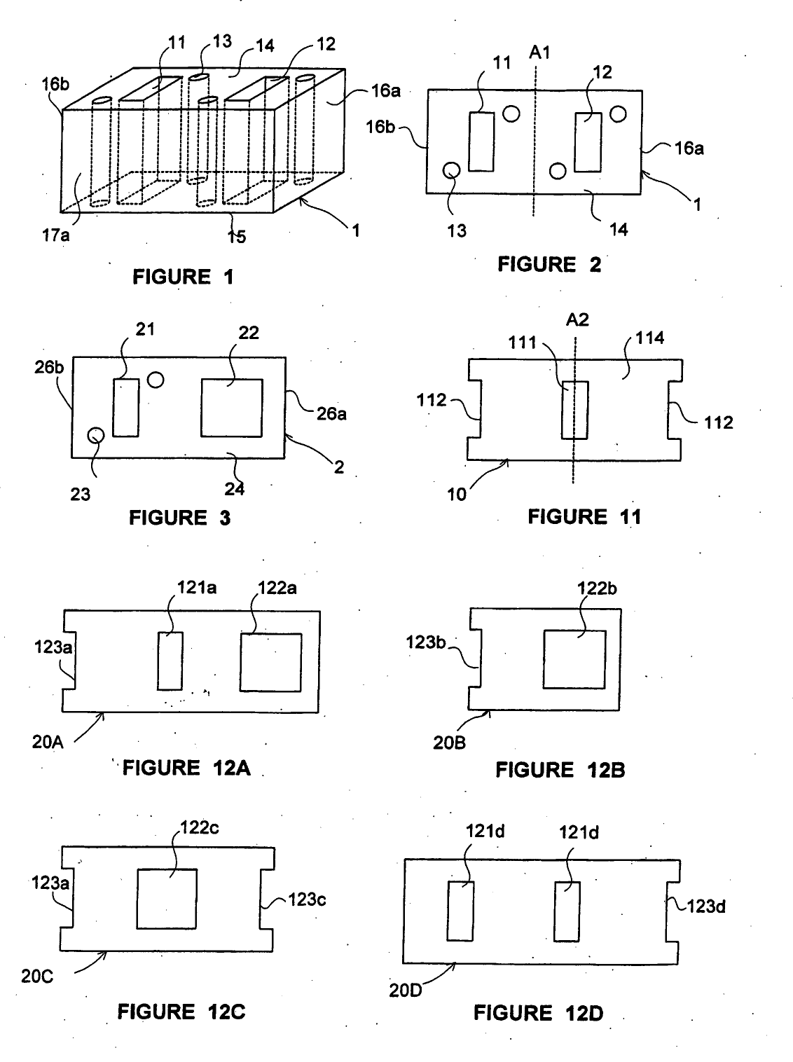

Referring to FIGS. 1 and 2, the blocks 1, called solid-wall blocks, have a rectangular, substantially parallelepided-shaped body provided with two vertical through-channels 11, 12, called main channels opening on to the upper face 14 and the lower face 15, and designed for the passage of the posts of the wooden framework.

The two main channels 11, 12 have identical rectangular cross-sections and are positioned symmetrically on either side of the transversal plane of symmetry A1 of the block, at a distance from the transversal faces 16a and 16b, the big opposite walls of the channels being positioned in parallel to said plane A1.

The block 1 also has channels 13 called secondary channels for the passage of electrical sheaths and/or conduits. The secondary channels are, for example, circular in section and there are four of them. One pair of secondary channels is positioned about each main channel 11, 12, the secondary channels of each pair being positioned symmetrically on either side of the vertical axis of a main channel, for example aligned along the small walls of the main channels.

For example, the solid-wall blocks have a length, a width and a height respectively of 600, 300 and 300 mm. The main channels have a 70×170 mm section and are designed for the passage of posts having a 50×50 mm section.

In this embodiment, the upper face 14 and the lower face 15, as well as the transversal side faces 16a, 16b and longitudinal faces 17a, 17b are substantially flat. Positioning means of the type having raised zones and matching recessed zones may naturally be planned on the upper and lower faces and/or on the transversal faces to facilitate the alignment of the blocks from one row to the other and/or one and the same row.

Referring to FIG. 3, specific blocks 2, called corner blocks, are designed for the wall corners and as well as for the partition wall junctions and for the window/door frames. These specific blocks 2 have external dimensions identical to those of the solid-wall blocks 1 and are provided with two main channels 21, 22, one of them 21 identical to the main channels 11 and 12 of the solid-wall blocks, the other 22 having a square section, for example a 170×170 mm section for the passage of bigger posts, for example posts with a 150×150 mm section. The specific block furthermore includes a pair of secondary channels 23 about the rectangular-sectioned main channel 21.

The technique of joining blocks to make walls, such as the bearing walls of a dwelling-type construction, is similar to that made with concrete blocks and bricks. Referring to FIG. 4, in which the secondary channels of the blocks have not been shown, the solid-wall blocks 1 are assembled to one another, for example by means of fat lime, in successive superimposed horizontal rows, the blocks of two successive rows being positioned quincunxially. Thus, the channels of superimposed blocks are substantially aligned vertically and form vertical conduits 3.

Once the blocks have been assembled, wooden posts 4 are slid in through the top up to the base of the construction in each of the conduits. A binder, such as milk of lime based on air-slaked lime and hydraulic lime is then poured into the conduits so as to seal the posts 4 in the blocks 1.

The specific blocks 2 can be used for the absorption of particular stresses by means of load-distribution posts having a bigger section, especially at each wall corner, partition and window/door frame. In the case of a wall corner, as illustrated in FIG. 5, i.e. a wall 6 comprising two portions 6a and 6b positioned at right angle, corner blocks of the two portions are interposed so that their square-sectioned channels 22 are aligned vertically to form a square-sectioned conduit in which a square-sectioned post 5 is then inserted by the top. As a variant, the square-sectioned post may be replaced by several rectangular posts nailed flat against one another.

The square-sectioned channels of the specific blocks may of course be replaced by channels used to obtain a continuous section conduit during the superimposition of the corner blocks at 90° to one another, such as circular-sectioned or polyhedron-sectioned channels.

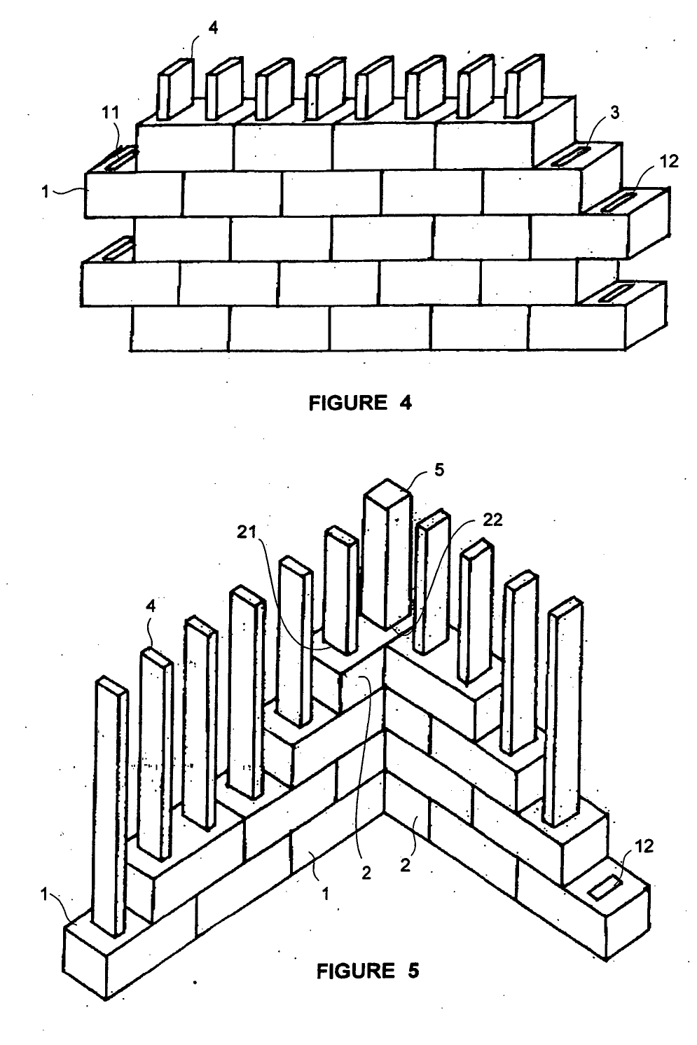

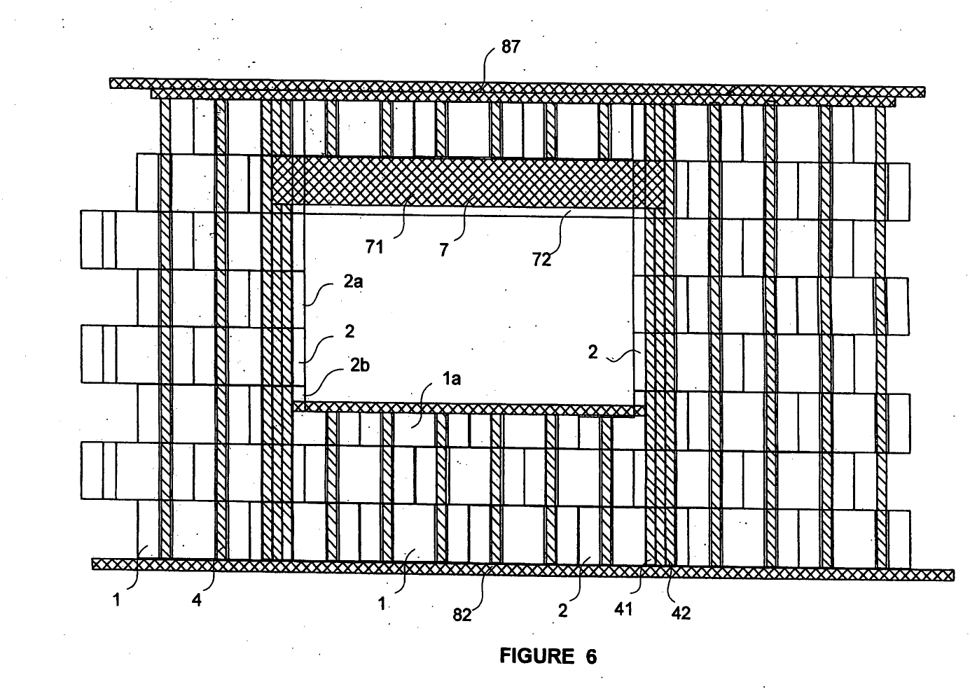

FIG. 6 illustrates the use of specific blocks 2 for uprights of a window. To help in the implementation and maintain unity of construction, the supports of the tops of the windows are formed by lintels 7 that are prefabricated and adjustable to the necessary length, comprising a wooden beam 71 clad with a layer 72 of hemp mortar. The lintels are mounted in position above the window/door frames as and when the wall is raised. The lintels are laid on supporting posts 41, 42 preliminarily cut into lengths and positioned in square-section conduits, then tied to them, for example by means of wooden connectors. The blocks 1, 2 can be easily cut out by handsaw or electrical saw in order to be brought to the desired size: these are blocks such as the solid-wall blocks referenced 1a and the specific blocks referenced 2a and 2bs in FIG. 6.

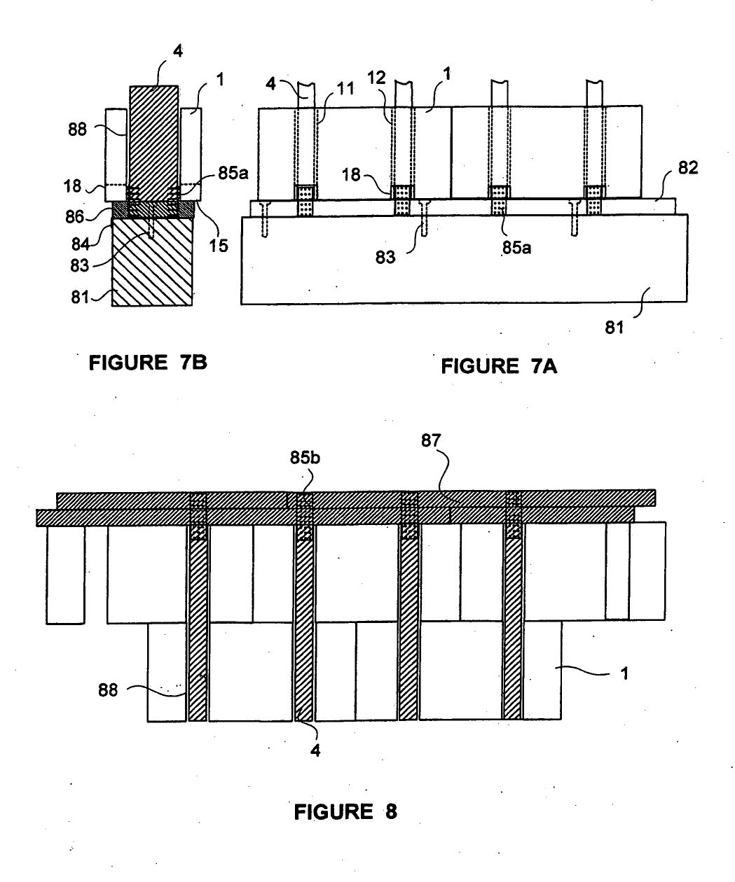

A more detailed description shall now be given of the mounting of the carrier walls of a dwelling using solid-wall blocks. The walls according to the invention may rest on concrete ground beams. As illustrated in FIGS. 7A and 7B, a sole plate or lower purlin made of wood 82 is sealed to the ground beams 81 to receive the posts 4 of the wooden frame. The sole plate has the same width as the blocks and has, for example, a 250×50 mm section. The sole plate is, for example, fixed to the ground beams by means of bolts 83 screwed into chemical anchors. This sole plate is treated so as not to undergo deterioration inherent to its low position in the edifice, and is advantageously isolated from capillary rise from the foundations, for example by means of a bituminous felt 84.

The first row of blocks 1 is placed directly on the sole plate 82. Before the blocks of the first row are mounted, a transversal groove 18 is made on their lower face 15, vertical to the main channels 11, 12 and opening on its longitudinal faces to enable the nailing of the lower connectors 85a between the lower purlin and the posts 4 and verify that the support of the posts is clean when they are mounted. The sealing of the blocks of the first row to one another is done with fat lime or air-slaked lime in a paste, spread on the transversal side faces of the blocks by means of a spatula or a trowel. The spacing, of about 5 cm, between the ground beam and the lower faces of the blocks, is jointed with a mortar 86 insensitive to run-off water, such as a natural hydraulic lime mortar, in maintaining access to the grooves 18. To prevent any subsequent problems, the first row will be mounted so as to be strictly horizontal so that the channels receiving the framework posts easily correspond from rank to rank.

After the first row has been positioned, the blocks are mounted contiguously in superimposed rows, with heightwise cross-joints, a paste of air-slaked lime being spread on the transversal faces and lower faces of the blocks. Once the wall has been mounted to the desired height, for example to joist height, the last row of blocks is struck off if necessary to obtain the desired height.

The posts 4 are slid in by the top until they take support on the sole plate in the conduits formed by the vertically aligned channels, then traced and cut square in height. The posts are then withdrawn. At each end, along the small sides of the posts, lower connectors 85a, and upper connectors 85b (FIG. 6) are fixed. These connectors are formed, for example, by metal plates that will be used to tie the posts with the lower sole plate and an upper belt purlin 87. The posts are then placed in the conduits, in taking care to clean the bearing surfaces at the base through the grooves and then they are fixed to the sole plate in nailing the lower connectors to the sole plate. From the top, using a sprinklers the empty spaces remaining between the posts and the walls of the channels are filled with milk of lime 88. A check will be made on the arrival of the milk of lime at the bottom of the posts by the grooves 18 of the blocks of the first row. At the top of the posts, the upper purlin 87 formed by two thicknesses of 50×150 mm section wooden structural elements placed flat, with offset joints and nailed together. The upper purlin is held in position by means of upper connectors 85b. At the corners or partition wall junctions, the joining of the purlins may be buttressed by square brackets or T-brackets. Floor beams could then be laid on the purlin by means of square connectors.

FIGS. 11, and 12A to 12D illustrate another embodiment of main and specific blocks for the making of walls. Referring to FIG. 11, the solid-wall blocks 10 include a rectangular-sectioned central vertical channel 111 similar to the main channels 11, 12 of the block 1 shown in FIGS. 1 and 2, arranged along the transversal plane A2 of the block, and lateral channels 112 formed by vertical depressions on the transversal faces which extend up to the upper face 114 and the lower face. The depth of the depressions is determined so that the section of the depressions corresponds to half of the section of the central channel. During the assembling, the facing depressions of successive blocks of a same row thus form a channel with a section substantially identical to that of the central channels 111. These blocks 10 may be assembled quincunxially in successively superimposed rows, the conduits for the insertion of the posts being formed by a vertical succession of central channels 111 and facing pairs of lateral channels 112.

Referring to FIG. 12A, specific blocks 20A for the wall corners, partition wall junctions and door frames may include a rectangular-sectioned channel 121a, a square-sectioned channel 122a in the vicinity of a transversal face and a side channel 123a formed on the transversal face opposite the square-sectioned channel. Specific blocks 20B of smaller length may include solely a square-sectioned section 122b and a lateral channel 123b, as illustrated in FIG. 12B. Referring to FIG. 12C, other specific blocks 20C may include a square-sectioned central channel 122c and a side channel 123c on each transversal face. Provision may also be made for specific blocks for solid-wall ends as illustrated in FIG. 12D, comprising two rectangular sectioned channels 121d, placed at a distance from the transversal faces, and one lateral channel 123d on one of the transversal faces, the other transversal face being flat.

The use of these different blocks in the making of a wall with window is illustrated schematically in FIG. 13.

A mode of making blocks according to the invention shall now be described.

The blocks are obtained by the molding of a hemp-and-lime based mortar. The mortar is formed for example out of a mixture of chevenotte, air-slaked lime and hydraulic lime and water,

Chevenotte, which is the internal part of the stem of the hemp plant, has a medium grain size, with a width of 1 to 5 mm and a length of 5 to 30 mm and is preferably fibre-free to prevent the appearance of pockets of water by draining during molding and disturbance of the lime carbonation process. Furthermore, the fines and dust, which tend to reduce the mechanical properties, will be preferably eliminated. The air-slaked quicklime (with a CaO content of over 90%) is advantageously slaked on the production site and used as a paste in order to ensure faster setting, smoothness greater than that of powdered slaked lime, a mixture of greater homogeneity and a percentage of water used that is lower by about 30 percent than that of a paste obtained from powdered slaked lime. Hydraulic lime can be used to create a structure with fast hydraulic setting giving the rough stripped-off block sufficient rigidity during its carbonation period.

Preferably, the mixture will furthermore include a pozzolanic reagent to make the mixture slightly hydraulic and obtain faster setting and greater resistance by pozzolanic reaction with air-slaked lime. The mixture may include additives such as, for example, moisturisers and plasticisers.

By way of an example, the following is the composition of a mixture for one m³ of the mortar:

1000 litres of chevenotte (115 to 130 kg)

fat lime (160 kg of quick lime+extinguishing water)

15 Kg of pozzolana

25 Kg of hydraulic lime

additives

water.

Air-slaked quicklime is slaked, for example, in a horizontal mixer with a continuous modulable flow. The mortar is obtained in a screw mixer. The mixture is fed continuously, for all the ingredients, and is modulated according to need.

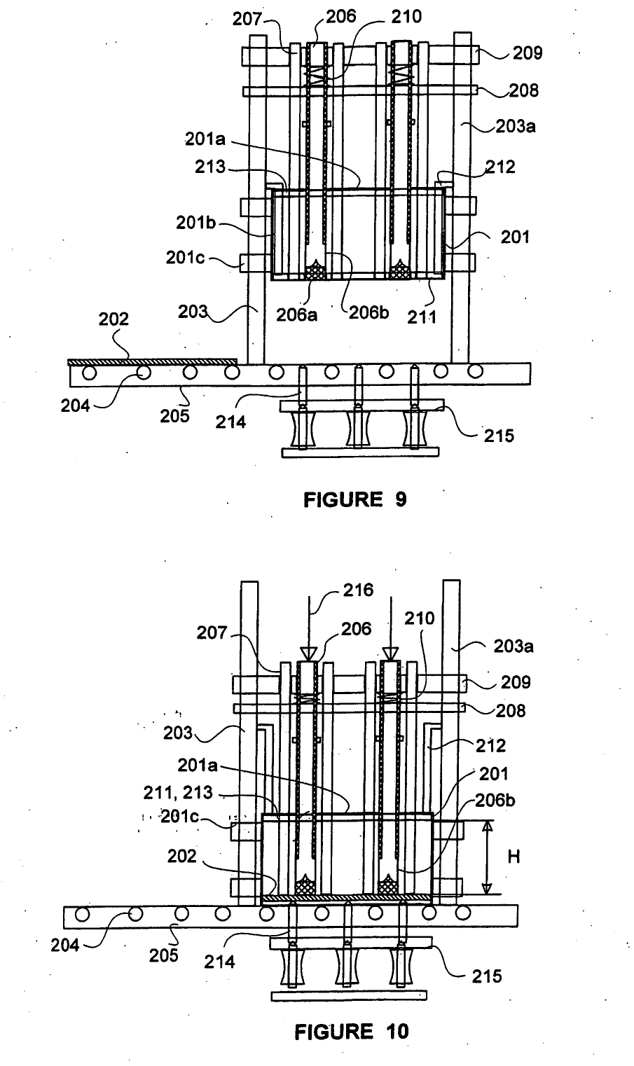

FIGS. 9 and 10 are drawings showing the principle of a block-molding device according to an embodiment of the present invention.

The block-molding device comprises a mold formed by a molding chamber 201 comprising a substantially horizontal upper wall 201b, surrounded by a peripheral sidewall 201b, and a counter-molding plate 202 whose dimensions correspond to the internal dimensions of the molding chamber.

The molding chamber is mounted so as to be mobile in vertical translation on the uprights 203a of a carrier chassis 203 by means of side toes 201c, above a conveyor 204, for example using rollers, designed to carry the counter-molding plate 202, said carrier chassis being mounted on a vibrating table 205 capable of making the chassis vibrate linearly. The upper wall 201a comprises apertures for the passage of rectangular-sectioned hollow main tubes 206, and hollow or solid, circular-sectioned secondary tubes 207 designed respectively to form the main and secondary channels during the molding of the blocks. The tubes 206, 207 are mounted on a supporting plate 208 mounted so as to be vertically sliding on the uprights 203a. The main tubes have an upper end that is open for the feeding the system with mortar and a lower end closed by a bar 206a. The large faces of the main tubes have opposite apertures 206b at their lower part.

The device has a guide plate 209 mounted so as to be sliding on the uprights above the supporting plate 208 and provided with apertures for the passage of the main tubes and secondary tubes. The supporting plate is assembled to this guide plate by elastic means represented schematically under reference 210. The vertical shift of the molding chamber 201 and of the guide plate 209 is given by first shifting means (not shown), for example pneumatic jack type means. The screen 211 is mounted so as to be fixedly joined to the carrier chassis by means of arms 212 which also pass through apertures of the upper wall 201a. In the top position of the molding chamber illustrated in FIG. 9, the screen 211 is positioned substantially at the level of the peripheral edge of the sidewall 201b of the molding chamber, the lower ends of the main and secondary tubes being engaged in apertures of the screen. In the low position illustrated in FIG. 10, the screen gets embedded in a counter-screen 213 positioned against the upper wall 201a and fixedly joined to this upper wall.

Bars or push-rods 214 serving to support the counter-molding plates are positioned straight on the molding chamber, for example interposed between the rollers of the conveyor. Second shifting means 215, comprising a silentbloc element, are positioned beneath the conveyor to act on the push-rods in order to shift the counter-molding plates upwards, toward the molding chamber.

Advantageously, the dimensions of the mold and the number and arrangement of the tubes are designed to form a molding stab from which several blocks according to the invention will be cut out.

The molding operation is done as follows. A counter-molding plate 202 is conveyed by the conveyor to the push rods 214, vertically to the molding chamber in the high position. The guide plate 209 to which the tubes are connected elastically and the molding chamber 201 are then shifted by the shifting means to the low position, as illustrated in FIG. 10. In this low position, the counter-molding plate is embedded in the molding chamber, the main tubes 206 and the secondary tubes 207 are elastically supported against the counter-molding plate respectively by the lower face of their bar 206a and by their lower end. The screen and the counter-screen of matching shape get nested into each other so as to form a substantially plane surface.

The mixture of bulked mortar is then injected by the other ends of the main tubes, as shown schematically by the arrows 216, to fill the molding chamber closed by the counter-molding plate. The mortar coming from the mixer is, for example, stored in a buffer container which feeds a dosing screw for direct injection of a specified quantity of mortar into the chamber. To facilitate the flow of mortar through the apertures 206b, the bars 206a advantageously have an upper face with an inverted V shape.

After filling, to reduce the bulking and obtain a homogeneous block, the mortar is compressed through the upward shifting of the counter-molding plate using second shifting means 215 that act on the push-rods, and is made to vibrate by putting the vibration table on which the chassis is mounted into vibration. During the shift, the tubes shift upwards against the elastic means, sliding in a tightly sealed manner in the apertures of the upper wall.

For example, the injected mortar shows bulking of about 10%. Thus, for a desired height H of 30 cm for the blocks, the initial distance between the counter-molding plate and the upper wall of the chamber, prior to the pressurized vibrating operation designed to chase out the air bubbles, is in the range of 33 cm.

The mold is made to vibrate under pressure for a determined time of about 10 to 20 seconds, for example in the range of 15 seconds. Then the molding chamber is brought into the top position illustrated in FIG. 9 to strip off the slab, the tubes being raised simultaneously to form the channels. Thus, the main tubes are used both to form the channels and feed the mold with mortar, the walls of the channels being deburred during the removal of the tubes. The stripping-off operation facilitated by the screen, the screen system and the counter-screen being used to prevent a marking of the upper face of the slab through suction effect.

The slab carried by the counter-plate is then shifted through the conveyor and simultaneously a new counter-molding plate is brought right on to the molding chamber for a new molding operation.

The slabs are then stored on carbonation racks, and then when the carbonation is sufficient to enable cutting, for example after about 21 days, the blocks are cut out from the slabs by sawing or slicing using a guillotine.

The block-making method of the invention therefore has a step for filling a mold with a constant volume of a mixture of hemp mortar and lime, a step of vibration under pressure of the mixture contained in the mold and then a stripping-off step. The molding operation is done in one stroke, thus preventing stratification, and the strip-off operation is done immediately after the pressurized vibration step.

According to one alternative embodiment, the molding device has one or more separation plates mounted fixedly to the supporting plate 208 and capable of sliding vertically in slots of the upper wall of the molding chamber and resting against the counter-molding plate to separate the molding chamber into different compartments, each corresponding to the dimensions of a block. The use of such separating plates makes it possible to avoid a subsequent step of cutting out the blocks from molded slabs.

Although the invention has been described with reference to a particular embodiment, it is clear that this description is in no way restricted and that it includes all the equivalent techniques of the means described as well as their combinations if these should come within the scope of the invention.

1. Method for making a wall out of hemp and lime, characterized in that it comprises:
a) a step for assembling hemp-and-lime based prefabricated blocks (1, 2) provided with vertical channels (11, 12, 21, 22) in which the blocks are assembled in superimposed, horizontal rows so as to form vertical conduits (3) with the vertical channels,
b) a step for the insertion of posts (4, 5), into the vertical conduits from the top, and
c) a step for filling the vertical conduits with a filling material to seal said posts into the blocks.

2. Method according to claim 1, characterized in that the assembling step consists of the quincunxial stacking in superimposed rows of the prefabricated blocks (1, 2) provided with at least two vertical channels (11, 12, 21, 22).

3. Method according to one of the claims 1 to 2, characterized in that the first row is positioned on a sole plate (82), on which the posts (4, 5) take support.

4. Method according to claim 3, characterized in that it comprises a step for fixing the posts (4, 5) to the sole plate (82) to position the posts in the vertical conduits before the step for filling said conduits with said filling material.

5. Method according to one of the above claim, characterized in that it comprises a step for fixing the posts (4, 5) by their upper ends to an upper purlin (87).

6. Prefabricated block made of hemp and lime for the implementation of the method according to one of the claims 1 to 5, characterized in that said block (1, 2, 10, 20A-20D) is made up of a parallelepiped-shaped single-piece body provided with vertical channels (11, 12, 21, 22, 111, 112, 121a, 122a, 123a, 122b, 123b, 122c, 123c, 121d, 123d) for the passage of posts (4, 5).

7. Block (1) according to claim 6, characterized in that it comprises two vertical through-channels (11, 12) of substantially identical rectangular cross-section that open out on its upper face (14) and lower face (15), placed symmetrically on either side of its transversal plane of symmetry (A1) and at a distance from its transversal sides (16A, 16B).

8. Block (2) according to claim 6, characterized in that it comprises two vertical through-channels of different rectangular cross-sections that open out on its upper and lower faces, at a distance from the transversal faces (26a, 26b), one (21) having a rectangular cross-section and the other having a bigger, square-shaped cross-section.

9. Device for the molding of hemp-and-lime blocks according to one of the claims 6 to 8, characterized in that it comprises:
a mold comprising a molding chamber (201) formed by an upper wall (201a) surrounded by a side wall (201b), said chamber being mounted so as to be vertically mobile on a chassis (203), and a counter-molding plate (202) positioned on a support means (214, 204) and capable of closing the molding chamber,
first shifting means to vertically shift the molding chamber between a top position in which the molding chamber is placed above the counter-molding plate for the stripping-off operation and a low position in which the counter-molding plate gets embedded in the molding chamber;
tubes (206, 207) mounted so as to be vertically mobile on said chassis, capable of coming vertically into the chamber through apertures present in the upper wall of this chamber, elastically supported on the counter-molding plate in the low position of the molding chamber to form the vertical channels of the blocks;
filling means (206) to fill the chamber with hemp mortar in its low position;
second shifting means (215) to effect an additional relative vertical shift of the counter-molding plate with respect to the molding chamber in its low position to compress the mortar present in the molding chamber; and
vibration means (215) to make the mold vibrate.

10. Device according to claim 9, characterized in that at least one of the tubes (206) is hollow and is provided at its lower part with at least one aperture (206b) to enable the molding chamber to be filled with hemp and lime in its low position.
